(19) United States
(12) Patent Application Publication
(10) Pub. No.: US 2026/0264543 A1
(43) Pub. Date: Sep. 10, 2026

(54) WIRELESS POWER TRANSFER STATION FOR WIRELESSLY TRANSMITTING ELECTRICAL POWER TO AN ELECTRICALLY MOTORIZED VEHICLE OR ELECTRICALLY MOTORIZED DEVICE

(71) Applicant: AWL-ELECTRICITY INC, MONTREAL (CA)

(72) Inventors: Dave DUFOUR, ST-HYACINTHE (CA); Cedric HAMEL-BRUNEAU, MONTREAL (CA); Francis BEAUCHAMP-VERDON, SAINT-LAMBERT (CA); Emmanuel GLEN, MONTREAL (CA)

(73) Assignee: AWL-ELECTRICITY INC, MONTREAL, QC (CA)

(21) Appl. No.: 19/149,568

(22) PCT Filed: Jan. 23, 2024
(86) PCT No.: PCT/CA2024/050078

§ 371 Date: Jul. 21, 2025

Related U.S. Application Data
(60) Provisional application No. 63/481,188, filed on Jan. 24, 2023.

(51) Int. Cl. B60L 53/12; B60L 53/36; B60L 53/38; H02J 50/05; H02J 50/90

(52) U.S. Cl. CPC B60L 53/12; B60L 53/36; B60L 53/38; H02J 50/05; H02J 50/90

(57) ABSTRACT

Wireless power transfer station for wirelessly transmitting electrical power to an electrical motorized vehicle or apparatus. The station comprises an electrode assembly comprising at least one electrode, an upper membrane and a lower membrane. The at least one electrode is located between the upper and lower membranes. The station also comprises a transmitter electronic circuit, and at least one electrical connection for respectively connecting the at least one electrode with the transmitter electronic circuit. For an electrical motorized vehicle, the station comprises an elevated alignment surface adapted for protecting the transmitter electronic circuit. For an electrical motorized apparatus, the station comprises a plurality of elevated alignment surfaces forming one or more indentation, the one or more indentation being adapted for positioning at least one electrode of the electrical motorized apparatus relative to the at least one electrode of the station to provide optimal wireless transmission of electrical power from the station to the electrical motorized apparatus.

### TECHNICAL FIELD

The present disclosure relates to the field of wireless power transfer of electrical energy. More specifically, the present disclosure presents a wireless power transfer station for wirelessly transmitting electrical power to an electrically motorized vehicle or an electrically motorized apparatus.

### BACKGROUND

Wireless power transfer of electrical energy is based on the capability of transferring electrical energy from a transmitter (which transfers power from an energy source, e.g., from an electrical outlet) to a receiver (which absorbs/extracts the transferred power), without establishing a physical contact between the transmitter and the receiver. The usage of wireless power transfer avoids the usage of an electrical connector (e.g., an electrical power outlet or a Universal Serial Bus (USB) cable) between the transmitter of electrical energy and the receiver of electrical energy.

Various techniques for implementing wireless power transfer have been known for a long time (although implementation of these techniques on an industrial and commercial scale are more recent). For example, induction systems use an induction coil at the transmitter and an induction coil at the receiver for implementing the wireless power transfer functionality. The wireless power transfer functionality is based on a coupling of magnetic fields generated between the induction coil of the transmitter and the induction coil of the receiver. The efficiency of induction systems can be improved by using resonant magnetic fields.

Another example includes electric field coupling systems, which use capacitive electrodes at the transmitter and the receiver for implementing the wireless power transfer functionality. The wireless power transfer functionality is based on a coupling of electric fields between the capacitive electrodes of the transmitter and the capacitive electrodes of the receiver. The efficiency of electric field coupling systems can be improved by using resonant electric fields.

Since more and more vehicles are using electrical power to operate their motors, there is a growing need for efficient, safe and reliable power transfer stations capable of wirelessly transferring electrical power to the electrically motorized vehicles. Similarly, more and more electrically motorized apparatuses (e.g., electrical tools like construction tools) rely on a rechargeable battery to store electrical power, for which there is also a growing need for efficient, safe and reliable power transfer stations capable of wirelessly transferring electrical power to the electrically motorized apparatuses. One important aspect is to ensure an optimal positioning of the electrically motorized vehicle or the electrically motorized apparatus with respect to the power transfer station, so that the wireless power transfer is performed in optimal conditions. One useful functionality for the power transfer station would therefore be to provide guidance to the electrically motorized vehicle or electrically motorized apparatus with respect to the optimal positioning, and to maintain the vehicle or electrically motorized apparatus in an adequate or optimal positioning. This would be particularly useful for specific types of electrically motorized vehicles, such as electrically powered wheelchairs. Another important aspect is to ensure that the electronic components of the power transfer station are protected when in use.

Therefore, there is a need for a new wireless power transfer station for wirelessly transmitting electrical power to an electrically motorized vehicle or electrically motorized apparatus.

### SUMMARY

According to a first aspect, the present disclosure provides a wireless power transfer station for wirelessly transmitting electrical power to an electrically motorized vehicle. The station comprises an electrode assembly comprising at least one electrode, an upper membrane and a lower membrane. The at least one electrode is located between the upper and lower membranes. The station also comprises a transmitter electronic circuit. The station further comprises at least one electrical connection, each electrical connection electrically connecting one of the at least one electrode with the transmitter electronic circuit. The station comprises an elevation adapted for protecting the transmitter electronic circuit.

In a particular aspect, the transmitter electronic circuit is located inside the elevation.

In another aspect, the elevation is positioned above the upper membrane, the elevation is encapsulated inside the upper membrane, or the elevation is integrated to the upper membrane.

In still another aspect, the elevation is not located above the at least one electrode.

In yet another aspect, the at least one electrode is encapsulated between the upper and lower membranes.

In another aspect, each electrode has one of the following shapes: circular, elliptic, square or rectangle.

In still another particular aspect, at least one of the upper membrane and the lower membrane is made of a material having at least one of the following characteristics: waterproof, weatherproof, anti-slip, resistant to mechanical constraints, dielectric and electrical insulator.

In yet another particular aspect, the electrode assembly comprises a group of electrodes, the group of electrodes comprising at least two electrodes, and the elevation is located at one extremity of the group of electrodes. In a particular embodiment, the electrodes of the group of electrodes are aligned parallel to each other.

In another particular aspect, the electrode assembly comprises two groups of electrodes, each group of electrodes comprising at least one electrode, and the elevation is located between the two groups of electrodes.

In still another particular aspect, the elevation is located at a center of the electrode assembly, and the electrode assembly comprises a plurality of electrodes located around the elevation.

In yet another particular aspect, the elevation is located at an extremity of the electrode assembly, and the electrode assembly comprises a plurality of electrodes, each electrode being located at a distance from the elevation.

In another particular aspect, the electrode assembly comprises at least one electrode and the elevation is located at a distance from the electrode. In a particular embodiment, the at least one electrode and the elevation are parallel to each other.

In still another particular aspect, the at least one electrode generates a capacitive electric field. In a particular embodiment, the capacitive electric field is a resonant capacitive electric field. In another particular embodiment, the elevation is further adapted for aligning the electrically motorized vehicle with respect to the electrode assembly. The wireless power transfer station wirelessly transmits electrical power to the electrically motorized vehicle when the electrically motorized vehicle is aligned with respect to the electrode assembly.

In yet another particular aspect, the electrode assembly is positioned above a floor. In a particular embodiment, a shape of the elevation provides for abutting at least one wheel of the electrically motorized vehicle against the elevation when the at least one wheel is located on top of the upper membrane.

In another particular aspect, the electrode assembly further comprises one passive plate for each electrode, each passive plate being located between the upper membrane and the lower membrane.

According to a second aspect, the present disclosure provides a wireless power transfer station for wirelessly transmitting electrical power to an electrically motorized apparatus comprising at least one electrode. The station comprises an electrode assembly comprising at least one electrode, an upper membrane and a lower membrane. The at least one electrode is located between the upper and lower membranes. The station also comprises a transmitter electronic circuit. The station further comprises at least one electrical connection, each electrical connection electrically connecting one of the at least one electrode with the transmitter electronic circuit. The station comprises a plurality of elevations forming one or more indentation. The one or more indentation is adapted for positioning the at least one electrode of the electrically motorized apparatus relative to the at least one electrode of the station to provide optimal wireless transmission of electrical power from the station to the electrically motorized apparatus.

In a particular aspect, the transmitter electronic circuit is located inside one of the plurality of elevations.

In another particular aspect, the elevation is positioned above the upper membrane, the elevation is encapsulated inside the upper membrane, or the elevation is integrated to the upper membrane.

In still another particular aspect, the at least one electrode is encapsulated between the upper and lower membranes.

In yet particular aspect, each electrode has one of the following shapes: circular, elliptic, square or rectangle.

In another particular aspect, at least one of the upper membrane and the lower membrane is made of a material having at least one of the following characteristics: waterproof, weatherproof, anti-slip, resistant to mechanical constraints, dielectric and electrical insulator.

In still another particular aspect, the at least one electrode generates a capacitive electric field. In a particular embodiment, the capacitive electric field is a resonant capacitive electric field.

In yet another particular aspect, the electrically motorized apparatus is one of the following: a rechargeable electrical tool or a removable rechargeable battery.

In another particular aspect, the electrode assembly further comprises one passive plate for each electrode, each passive plate being located between the upper membrane and the lower membrane.

### BRIEF DESCRIPTION OF THE DRAWINGS

Embodiments of the disclosure will be described by way of example only with reference to the accompanying drawings, in which:

FIG. 1 is a schematic representation of a wireless power transfer station for an electrically motorized vehicle;

FIGS. 2A, 2B and 2C represent respective front, top and bottom views of an electrode assembly of the wireless power transfer station of FIG. 1;

FIGS. 3A, 3B and 3C represent respective front, top and perspective views of an exemplary implementation of the wireless power transfer station of FIG. 1;

FIGS. 4A, 4B and 4C represent respective front, top and perspective views of another exemplary implementation of the wireless power transfer station of FIG. 1;

FIGS. 5A, 5B and 5C represent respective front, top and perspective views of still another exemplary implementation of the wireless power transfer station of FIG. 1;

FIGS. 6A, 6B and 6C represent respective front, top and perspective views of yet another exemplary implementation of the wireless power transfer station of FIG. 1;

FIGS. 7A, 7B and 7C represent respective front, top and perspective views of still another exemplary implementation of the wireless power transfer station of FIG. 1;

FIGS. 8A, 8B and 8C represent respective front, top and perspective views of yet another exemplary implementation of the wireless power transfer station of FIG. 1;

FIGS. 9A and 9B represent respective perspective views of still another exemplary implementation of the wireless power transfer station of FIG. 1;

FIG. 10 represents a perspective view of yet another exemplary implementation of the wireless power transfer station of FIG. 1;

FIG. 11 is a schematic representation of a wireless power receiver;

FIGS. 12A and 12B represent respective front and top views of an exemplary implementation of a wireless power transfer station for electrical motorized apparatuses;

FIGS. 12C and 12D represent a side view of the wireless power transfer station of FIGS. 12A and 12B;

FIGS. 13A and 13B represent respective top and side views of another exemplary implementation of a wireless power transfer station for electrically motorized apparatuses;

FIG. 14A represents a side view of an exemplary implementation of elevation; and

FIG. 14B represents a top view of another exemplary implementation of a wireless power transfer station for electrically motorized apparatuses using four elevations illustrated in FIG. 14A.

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to the improvement of the design and functionalities of wireless power transfer stations capable of wirelessly transferring electrical power to electrically motorized vehicles or electrically motorized apparatuses such as for example electric wheelchairs, electric bikes, electric scooters, golf carts, robots, construction tools, etc.

### Wireless Power Transfer Station for Electrically Motorized Vehicles

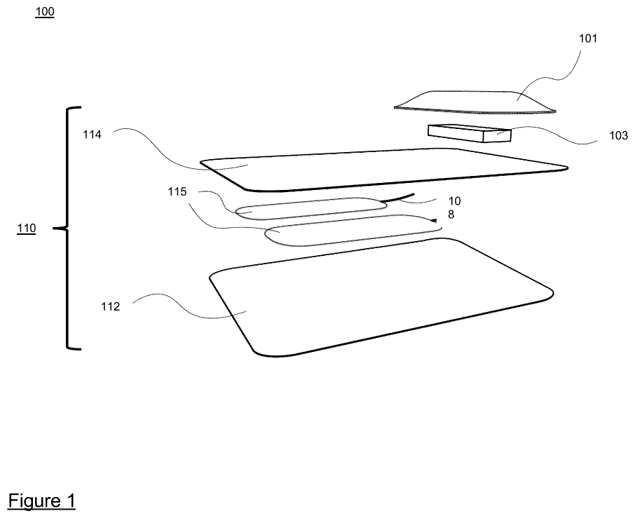

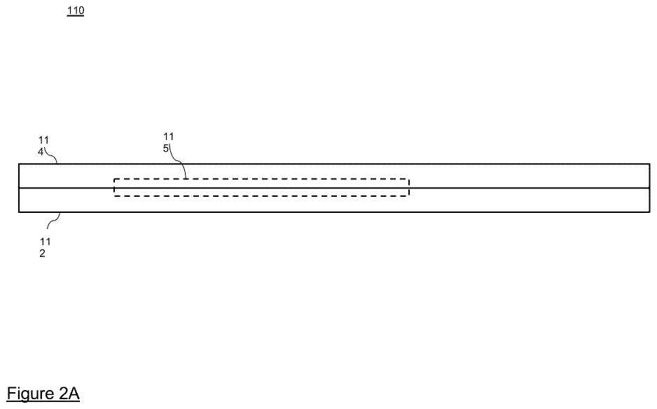

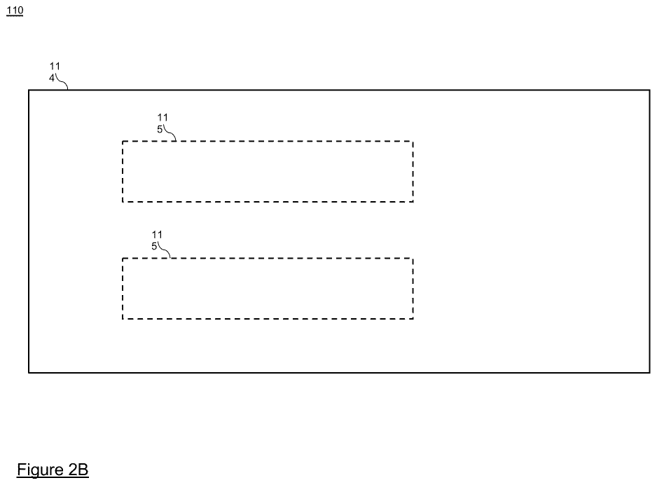

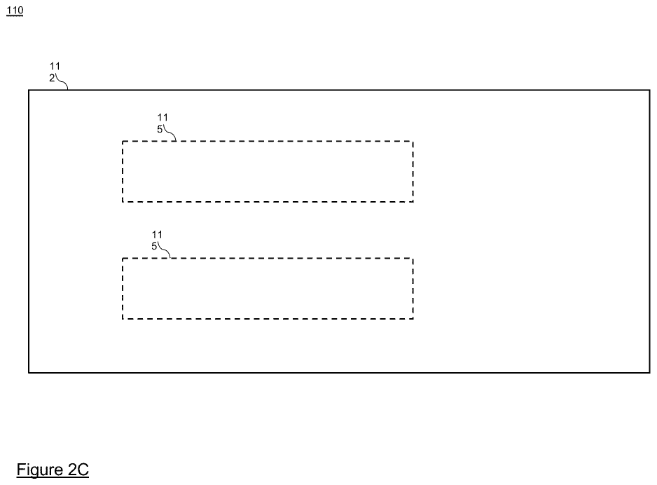

Reference is now made concurrently to FIGS. 1, 2A, 2B and 2C. A schematic representation of a wireless power transfer (WPT) station 100 for example for electrically motorized vehicles is provided in FIG. 1. The WPT station 100 is adapted for wirelessly transmitting electrical power to a wireless power receiver (not represented in FIG. 1) of the electrically motorized vehicle. Details of the wireless power receiver will be provided later in the description. The wireless power receiver may be integrated to various types of electrically motorized vehicles, which can be recharged via the WPT station 100. Examples of electrically motorized vehicles include an electrically powered wheelchair, an electrically powered scooter, an electrically powered bicycle, an electrically powered car, an electrically powered drone, an electrically powered plane, an electrically powered robot, etc.

In an exemplary configuration, the WPT station 100 is adapted to be installed on a floor inside any type of building (residential building, commercial building, parking, etc.). The WPT station 100 is also adapted to be installed on a floor outside of a building (in this case, some components of the WPT station 100 may have specific characteristics to resist to various weather conditions).

The WPT station 100 comprises an electrode assembly 110. The electrode assembly 110 comprises at least one electrode 115, an upper membrane 114 and a lower membrane 112. FIG. 1 illustrates a WPT station 100 comprising two electrodes 115. However, the number of electrodes 115 may vary based on a particular design of the WPT station 100, a particular usage of the WPT station 100, a particular location of the WPT station 100, etc. Each electrode 115 is located between the upper membrane 114 and the lower membrane 112. For example, each electrode 115 is encapsulated between the upper membrane 114 and the lower membrane 112. In a particular implementation, the WPT station 100 is provided with at least one pair of electrodes 115, where the pair of electrodes 115 are adapted for generating an electric field by resonant capacitive coupling.

When the WPT station 100 is adapted to be installed on a floor, the electrode assembly 110 is positioned above the floor. In this configuration, the lower membrane 112 is directly in contact with the floor. Alternatively, the lower membrane 112 is not directly in contact with the floor.

The upper membrane 114 and lower membrane 112 can be made of at least one of the following materials: vinyl, neoprene, a polymer, a textile, a combination thereof, etc. The upper membrane 114 and lower membrane 112 are not necessarily made of the same material(s).

The upper membrane 114 and lower membrane 112 may have various characteristics, depending on specific usage and operating conditions of the WPT station 100. For example, at least one of the upper membrane 114 and the lower membrane 112 is made of a material having at least one of the following characteristics: waterproof, weatherproof, anti-slip, resistant to mechanical constraints, dielectric and electrical insulator.

Furthermore, the upper membrane 114 and lower membrane 112 provide the following functionalities: protecting and maintaining the components (e.g., electrodes 115) located between the two membranes 112 and 114, isolating the electrical components (e.g., electrodes 115) located between the two membranes 112 and 114 (for instance to prevent an electrical shock caused by a contact with one of the electrodes 115).

The electrode(s) 115 may have various shapes, including of the following shapes: circular, elliptic, square, rectangle, etc. FIG. 1 illustrates still another shape for the electrode(s) 115 comprising an elongated rectangle and two half circles at two respective extremities of the elongated rectangle.

The WPT station 100 comprises a transmitter electronic circuit 103. The transmitter electronic circuit 103 is generally located inside a protective container (e.g., inside a protective box). For example, as illustrated in FIG. 1, an elevated control surface 101 plays the role of the protective container.

The WPT station 100 comprises at least one electrical connection 108. Each electrical connection 108 electrically connects one of the electrodes 115 with the transmitter electronic circuit 103. FIG. 1 illustrates a WPT station 100 comprising two electrical connections 108 for respectively connecting the two electrodes 115 to the transmitter electronic circuit 103. Only a portion of the electrical connections 108 is illustrated in FIG. 1 for simplification purposes.

The transmitter electronic circuit 103 comprises electrical and electronic components adapted for generating a capacitive electric field at each electrode 115. The WPT station 100 transmits electrical power to the wireless power receiver of the electrically motorized vehicle via capacitive coupling with the capacitive electric field. In a particular embodiment, the capacitive electric field is a resonant capacitive electric field.

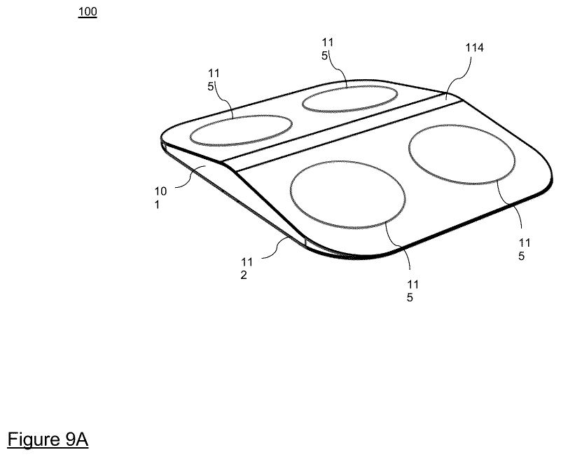

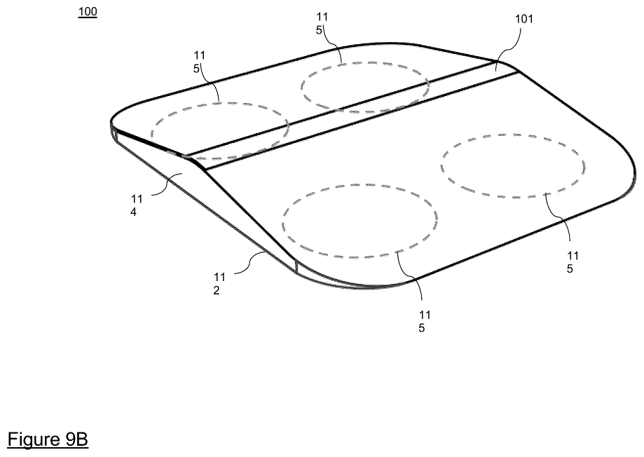

The WPT station 100 comprises the elevated alignment surface 101. The elevated alignment surface 101 is adapted for providing at least one of the following functionalities: protecting the transmitter electronic circuit 103 (by playing the role of the protective container) and/or aligning the electrically motorized vehicle with respect to the electrode assembly. FIG. 1 illustrates a configuration where the elevated control surface 101 is positioned above the upper membrane 114. In another configuration not illustrated in the Figures, the elevated alignment surface 101 is encapsulated inside the upper membrane 114. In still another configuration (illustrated for example in FIG. 9A), the elevated alignment surface 101 is directly integrated to the upper membrane 114 (e.g., the upper membrane 114 is a thermoformed piece of plastic including the elevated alignment surface 101).

The transmission of electrical power from the WPT station 100 to the wireless power receiver of the electrically motorized vehicle is performed when the electrically motorized vehicle is aligned with respect to the elevated alignment surface 101. As mentioned previously, the elevated alignment surface facilitates or forces alignment of the electrically motorized vehicle with respect to the electrode assembly. The electrically motorized vehicle is at least partially positioned above the upper membrane 114 when the transmission of electrical power from the WPT station 100 to the wireless power receiver of the electrically motorized vehicle is performed.

Furthermore, the elevated alignment surface 101 further stops the movement of the electrically motorized vehicle on the WPT station 100 and maintains the electrically motorized vehicle in position when performing the transfer of electrical power. For example, the shape of the elevated alignment surface 101 provides for abutting at least one wheel of the electrically motorized vehicle against the elevated alignment surface 101 when the at least one wheel is located on top of the upper membrane 114. Additionally, the elevated alignment surface 101 may be shaped to allow passage of the electrically motorized vehicle over the elevated alignment surface 101 in a secure manner. For example, a slope of the elevated alignment surface 101 is adapted to allow a wheel of the electrically motorized vehicle to smoothly pass over the elevated alignment surface 101.

FIG. 1 illustrates a configuration where the elevated alignment surface 101 is not located above the electrode(s) 115. Alternatively, the elevated alignment surface 101 is at least partially located above the electrode(s) 115.

FIG. 1 illustrates a configuration where the transmitter electronic circuit 103 is located inside the elevated alignment surface 101. Alternatively, the transmitter electronic circuit 103 may be located outside of the elevated alignment surface 101.

When the transmitter electronic circuit 103 is located inside the elevated alignment surface 101, the elevated alignment surface 101 protects the transmitter electronic circuit 103. More specifically, the elevated alignment surface 101 provides at least some of the following functionalities with respect to the transmitter electronic circuit 103: protecting and maintaining the electrical/electronical components of the transmitter electronic circuit 103, isolating the transmitter electronic circuit 103 (for instance to prevent an electrical shock caused by a contact with the transmitter electronic circuit 103), aeration of the transmitter electronic circuit 103 to maintain an optimal temperature.

The elevated alignment surface 101 can be made of at least one of the following materials: a polymer, a resin, a metal, a combination thereof, etc. The material composition of the elevated alignment surface 101 generally provides at least some of the following characteristics: resistance to mechanical constraints, resistance to adverse weather conditions, dielectric capabilities, heat dissipation. For example, the elevated alignment surface 101 is made at least partially of metal and provides passive heat dissipation (in a manner similar to a heatsink).

In the rest of the description, various implementations of the WPT station 100 based on the general design illustrated in FIG. 1 will be provided. Furthermore, additional implementations of the WPT station 100 will be provided, might differ at least partially from the general design illustrated in FIG. 1.

Additionally, although the WPT station 100 has been described as a WPT station adapted to be installed on the floor, the WPT station 100 can be adapted to be installed on a wall or a roof of a building. The WPT station 100 may also be mobile, for example to be movable from one room to another room of an hospital (e.g., the WPT station 100 is installed on a moving cart).

FIGS. 2A, 2B and 2C respectively provide a front view, a top view, and a bottom view of the electrode assembly 110 (comprising the two electrodes 105, the upper membrane 114 and the lower membrane 112). For simplification purposes, the electrode assembly 110 is not identified with a reference number in the rest of the Figures. Only its components (the electrodes 105, the upper membrane 114 and the lower membrane 112) are identified with reference numbers.

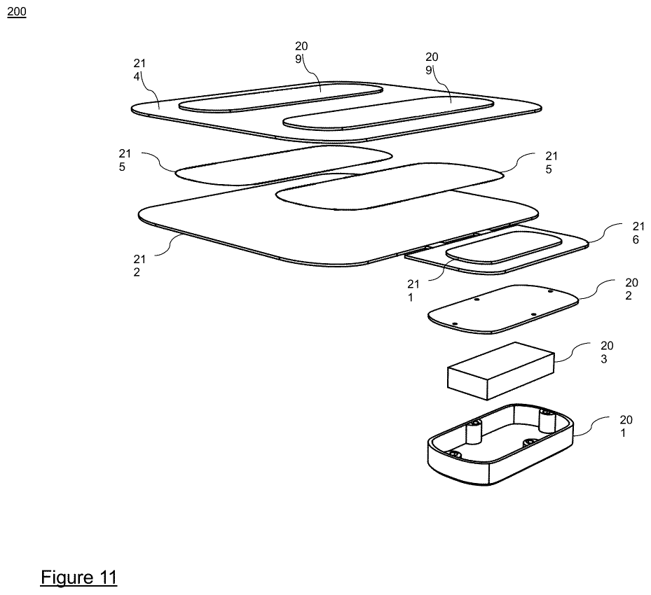

Optionally, the WPT station 100 comprises a passive plate for each electrode 115. For example, in the configuration illustrated in FIGS. 1, 2A, 2B and 2C, the WPT station 100 could comprise two passive plates (not represented in the Figures for simplification purposes), each passive plate being associated to one of the two electrodes 115. The one or more passive plate is made of a conductive material. Examples of conductive materials which can be used for the passive plate(s) comprise aluminum, copper, gold, etc. The one or more passive plate is located between the upper membrane 114 and the lower membrane 112. In an exemplary configuration, the one or more passive plate is located above the lower membrane 112, each electrode 115 is located above its respective corresponding passive plate, and the upper membrane is located above the electrodes 115. In an alternative implementation, the WPT station 100 comprises several (two or more) layers of passive plate(s). The usage of passive plates may increase the efficiency of the WPT station 100: the passive plates beam/shape the electric field, by reducing cross-coupling of electrodes 115 (e.g., reducing a left side emitter electrode 115 coupling with a right-side receiver electrode 215 illustrated in FIG. 11).

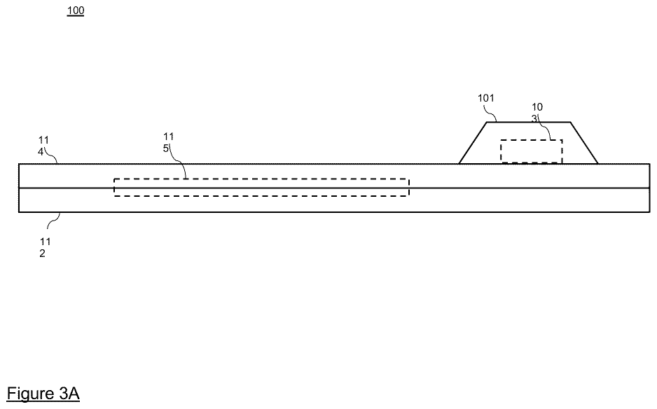

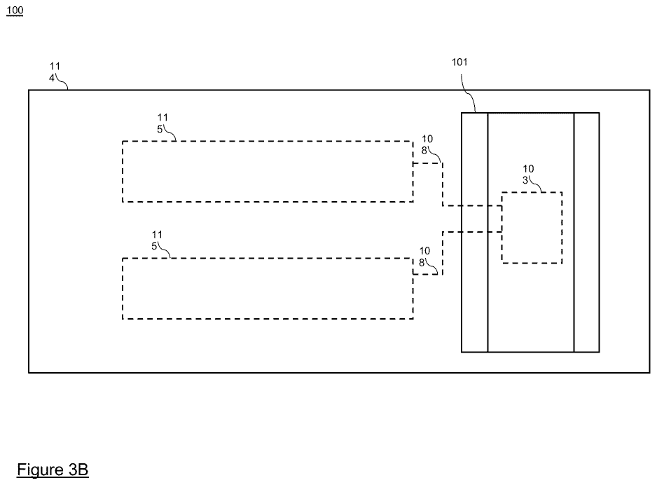

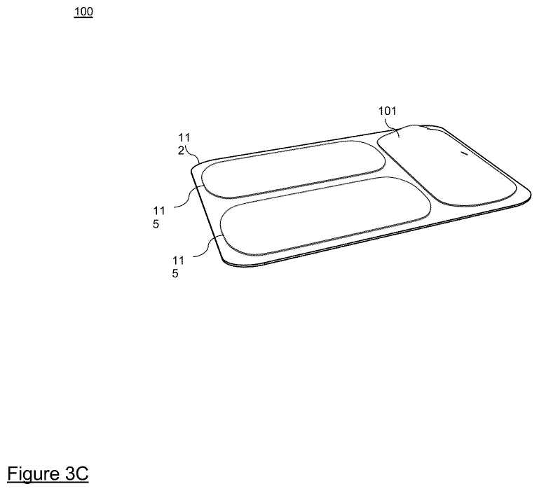

Reference is now made concurrently to FIGS. 3A and 3B, where FIG. 3A is a front view and FIG. 3B is a top view of an exemplary implementation of the WPT station 100 illustrated in FIG. 1.

The WPT station 100 comprises the electrode assembly, which comprises the upper membrane 114, the lower membrane 112, and two electrodes 115 located between the upper membrane 114 and the lower membrane 112.

The WPT station 100 comprises the elevated alignment surface 101 with the transmitter electronic circuit 103 located inside the elevated alignment surface 101. The elevated alignment surface 101 is positioned above the upper membrane 114 and is not located above the two electrodes 115.

FIG. 3B also represents two electrical connections 108 for respectively connecting one of the electrodes 115 to the electronic circuit 103. The two electrical connections 108 are not represented in FIG. 3A for simplification purposes.

The exemplary implementation of FIGS. 3A and 3B can be generalized to a group of electrodes 115 (two or more), with the elevated alignment surface 101 located at one extremity of the group of electrodes 115. FIGS. 3A and 3B illustrate the electrodes 115 being aligned parallel to each other. Alternatively, the electrodes 115 may be grouped in a way where they are not parallel to each other.

Reference is now made concurrently to FIGS. 3A, 3B and 3C, where FIG. 3C is a perspective view of an alternative exemplary implementation of the WPT station 100 illustrated in FIGS. 3A and 3B.

The electrode assembly of the WPT station 100 illustrated in FIG. 3C only comprises the lower membrane 112 but does not comprise an upper membrane 114. The two electrodes 115 are located above the lower membrane 112. Each electrode 115 comprises its own upper membrane (not represented in FIG. 3C), which plays the role of the upper membrane 114 illustrated in FIGS. 3A and 3B (e.g., protection against electrical shock). For example, the upper membrane of each electrode 115 is made of a dielectric material.

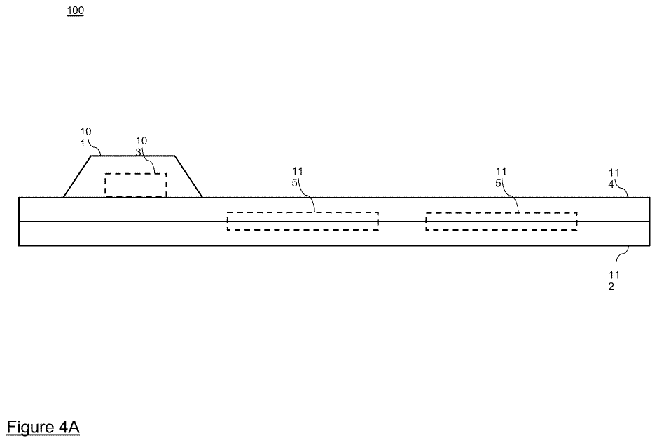

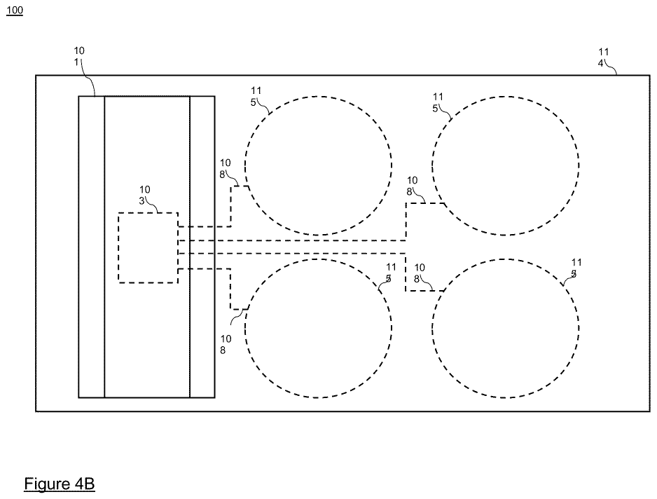

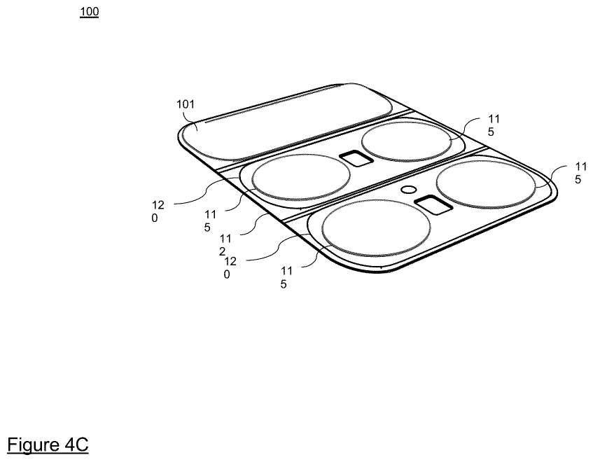

Reference is now made concurrently to FIGS. 4A and 4B, where FIG. 4A is a front view and FIG. 4B is a top view of another exemplary implementation of the WPT station 100 illustrated in FIG. 1.

The WPT station 100 comprises the electrode assembly, which comprises the upper membrane 114, the lower membrane 112, and four electrodes 115 located between the upper membrane 114 and the lower membrane 112.

The WPT station 100 comprises the elevated alignment surface 101 with the transmitter electronic circuit 103 located inside the elevated alignment surface 101. The elevated alignment surface 101 is positioned above the upper membrane 114 and is not located above the four electrodes 115.

FIG. 4B also represents four electrical connections 108 for respectively connecting one of the electrodes 115 to the electronic circuit 103. The four electrical connections 108 are not represented in FIG. 4A for simplification purposes.

FIGS. 4A and 4B illustrates the exemplary implementation comprising a group of electrodes 115 (two or more), with the elevated alignment surface 101 being located at one extremity of the group of electrodes 115. The electrodes 115 of FIGS. 4A and 4B have a circular shape. As mentioned previously, the electrodes 115 may have other shapes.

Reference is now made concurrently to FIGS. 4A, 4B and 4C, where FIG. 4C is a perspective view of an alternative exemplary implementation of the WPT station 100 illustrated in FIGS. 4A and 4B.

The electrode assembly of the WPT station 100 illustrated in FIG. 4C only comprises the lower membrane 112 but does not comprise an upper membrane 114. The four electrodes 115 are located above the lower membrane 112. As mentioned previously, each electrode 115 comprises its own upper membrane (not represented separately in FIG. 4C), which plays the role of the upper membrane 114 illustrated in FIGS. 4A and 4B.

FIG. 4C further illustrates two intermediate layers 120 being respectively positioned between two sub-groups of two electrodes 115 and the lower membrane 112. The intermediate layers 120 are part of the electrode assembly and are used for securing and protecting the electrodes 115.

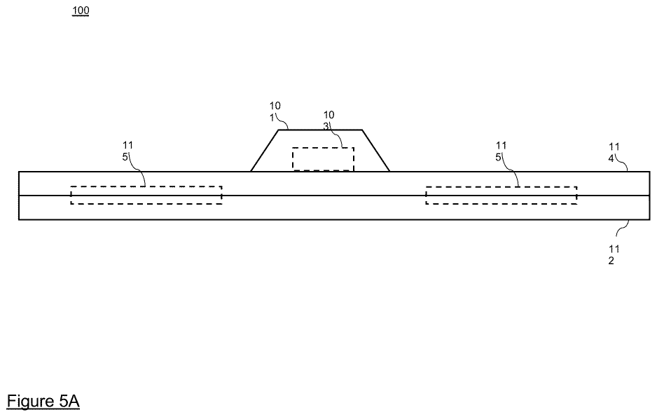

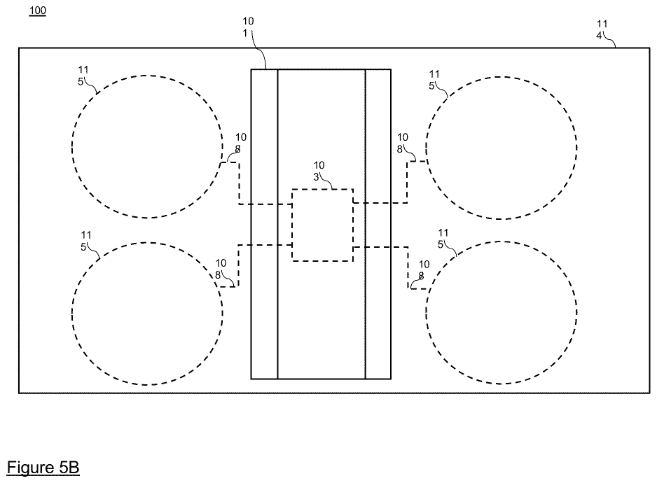

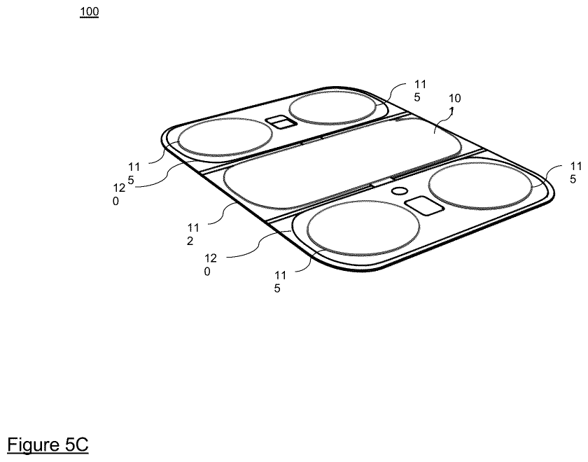

Reference is now made concurrently to FIGS. 5A and 5B, where FIG. 5A is a front view and FIG. 5B is a top view of still another exemplary implementation of the WPT station 100 illustrated in FIG. 1.

The WPT station 100 comprises the electrode assembly, which comprises the upper membrane 114, the lower membrane 112, and four electrodes 115 located between the upper membrane 114 and the lower membrane 112.

The WPT station 100 comprises the elevated alignment surface 101 with the transmitter electronic circuit 103 located inside the elevated alignment surface 101. The elevated alignment surface 101 is positioned above the upper membrane 114 and is not located above the four electrodes 115.

FIG. 5B also represents four electrical connections 108 for respectively connecting one of the electrodes 115 to the electronic circuit 103. The four electrical connections 108 are not represented in FIG. 5A for simplification purposes.

The exemplary implementation of FIGS. 5A and 5B can be generalized to two groups of electrodes 115, with the elevated alignment surface 101 being located between the two groups of electrodes 115. Each group has the same number of electrodes 115. Alternatively, each group has a different number of electrodes 115. Each group generally comprises at least two electrodes (as illustrated in FIGS. 5A and 5B). However, the notion of group can be extended to a single electrode 115. For example, the WPT station 100 comprises two electrodes 115 and the elevated alignment surface 101 is located between the two electrodes 115.

Reference is now made concurrently to FIGS. 5A, 5B and 5C, where FIG. 5C is a perspective view of an alternative exemplary implementation of the WPT station 100 illustrated in FIGS. 5A and 5B.

The electrode assembly of the WPT station 100 illustrated in FIG. 5C only comprises the lower membrane 112 but does not comprise an upper membrane 114. The four electrodes 115 are located above the lower membrane 112. As mentioned previously, each electrode 115 comprises its own upper membrane (not represented in FIG. 5C), which plays the role of the upper membrane 114 illustrated in FIGS. 5A and 5B.

FIG. 5C further illustrates two intermediate layers 120 being respectively positioned between each group of electrodes 115 and the lower membrane 112. The role of the intermediate layers 120 has been described previously.

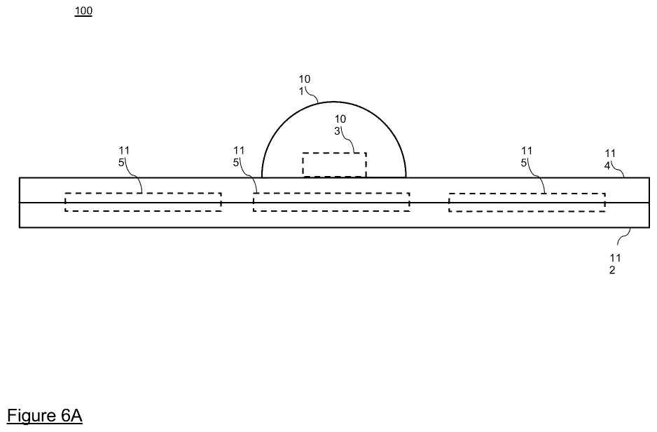

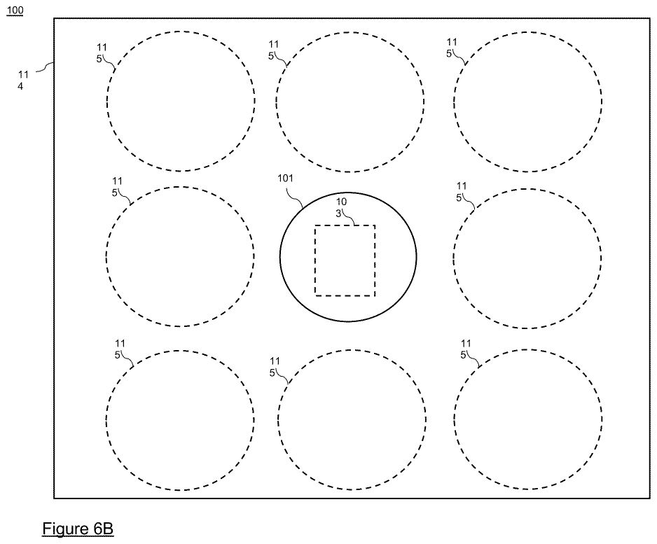

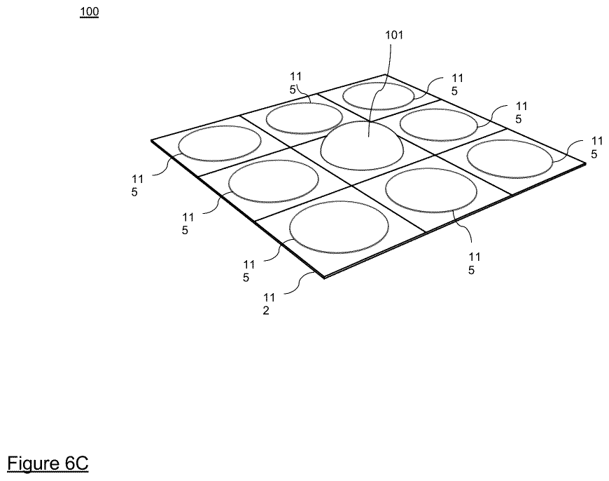

Reference is now made concurrently to FIGS. 6A and 6B, where FIG. 6A is a front view and FIG. 6B is a top view of yet another exemplary implementation of the WPT station 100 illustrated in FIG. 1.

The WPT station 100 comprises the electrode assembly, which comprises the upper membrane 114, the lower membrane 112, and a plurality of electrodes 115 located between the upper membrane 114 and the lower membrane 112.

The WPT station 100 comprises the elevated alignment surface 101 with the transmitter electronic circuit 103 located inside the elevated alignment surface 101. The elevated alignment surface 101 is positioned above the upper membrane 114 and is not located above the group of electrodes 115.

The elevated alignment surface 101 is positioned at a center of the electrode assembly, and the plurality of electrodes 115 are located around the elevated alignment surface 101. More specifically, in the configuration illustrated in FIGS. 6A and 6B, the elevated alignment surface 101 is located above a center of the upper membrane 114.

The electrical connections for respectively connecting one of the electrodes 115 to the electronic circuit 103 are not represented in FIGS. 6A and 6B for simplification purposes.

FIGS. 6A and 6B illustrate an exemplary configuration where the upper membrane 114 and the lower membrane 112 have a square shape, the electrodes 115 have a circular shape, the plurality of electrodes 115 comprises eight electrodes, and the elevated alignment surface 101 has a semi-spherical shape. A person skilled in the art would readily understand that this exemplary configuration can be adapted, while maintaining the property of having the elevated alignment surface 101 positioned at a center of the electrode assembly, and the plurality of electrodes 115 being located around the elevated alignment surface 101.

Reference is now made concurrently to FIGS. 6A, 6B and 6C, where FIG. 6C is a perspective view of an alternative exemplary implementation of the WPT station 100 illustrated in FIGS. 6A and 6B.

The electrode assembly of the WPT station 100 illustrated in FIG. 6C only comprises the lower membrane 112 but does not comprise an upper membrane 114. The plurality of electrodes 115 are located above the lower membrane 112. As mentioned previously, each electrode 115 comprises its own upper membrane (not represented in FIG. 6C), which plays the role of the upper membrane 114 illustrated in FIGS. 6A and 6B.

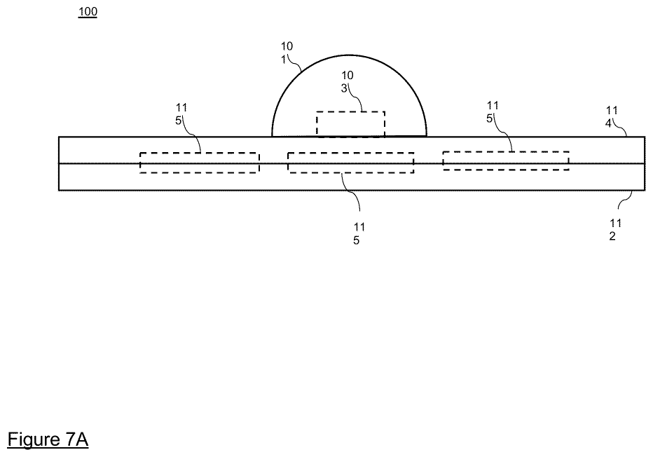

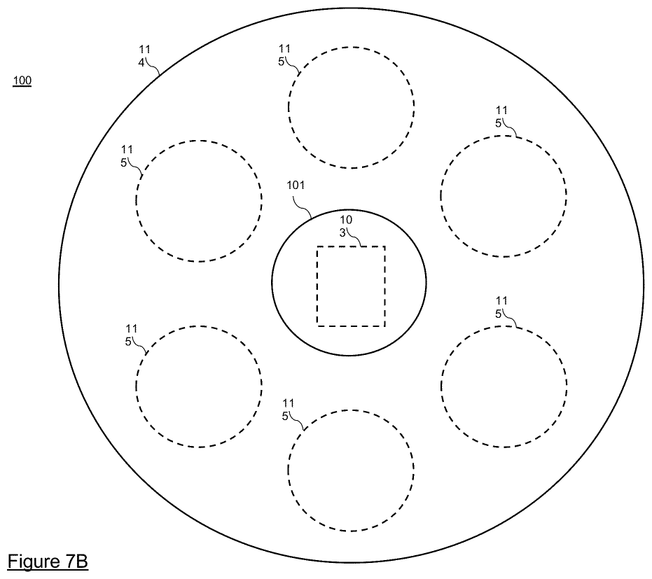

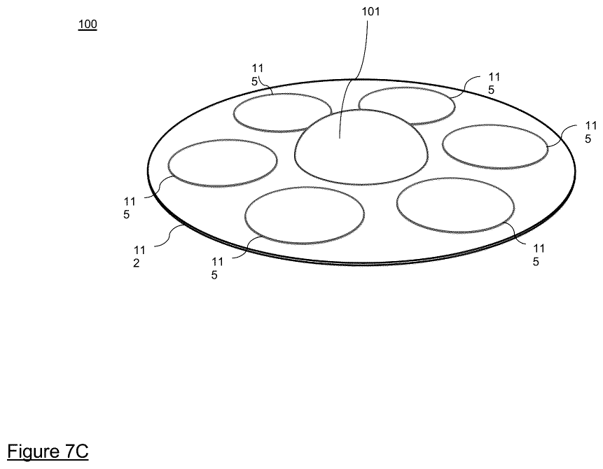

Reference is now made concurrently to FIGS. 7A and 7B, where FIG. 7A is a front view and FIG. 7B is a top view of another exemplary implementation of the WPT station 100 illustrated in FIG. 1.

The implementation of the WPT station 100 illustrated in FIGS. 7A and 7B is similar to the implementation illustrated in FIGS. 6A and 6B, except for the shape of the upper membrane 114 and lower membrane 112 being a circular shape instead of a square shape. Furthermore, the number of electrodes 115 is different (six instead of eight).

Reference is now made concurrently to FIGS. 7A, 7B and 7C, where FIG. 7C is a perspective view of an alternative exemplary implementation of the WPT station 100 illustrated in FIGS. 7A and 7B.

As mentioned previously, the implementation of the WPT station 100 illustrated in FIG. 7C is similar to the implementation illustrated in FIG. 6C, except for the shape of the upper membrane 114 and lower membrane 112 being a circular shape instead of a square shape. Furthermore, the number of electrodes 115 is different (six instead of eight).

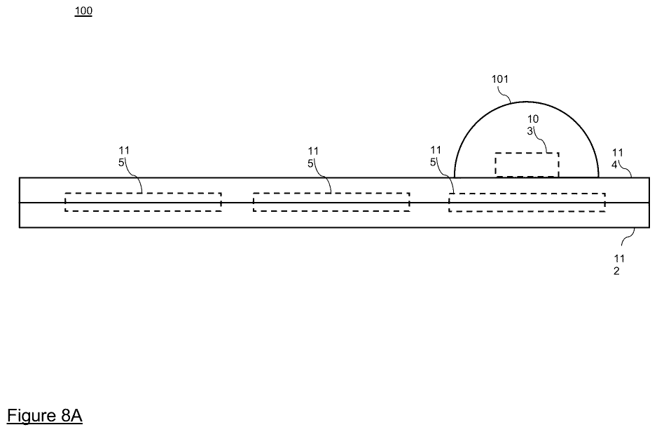

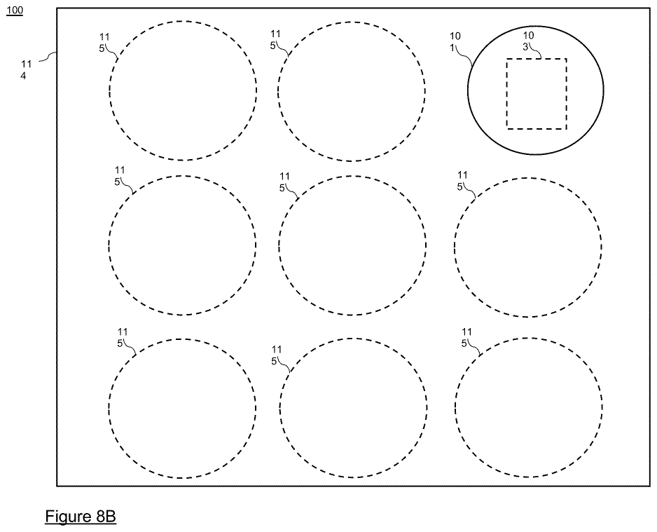

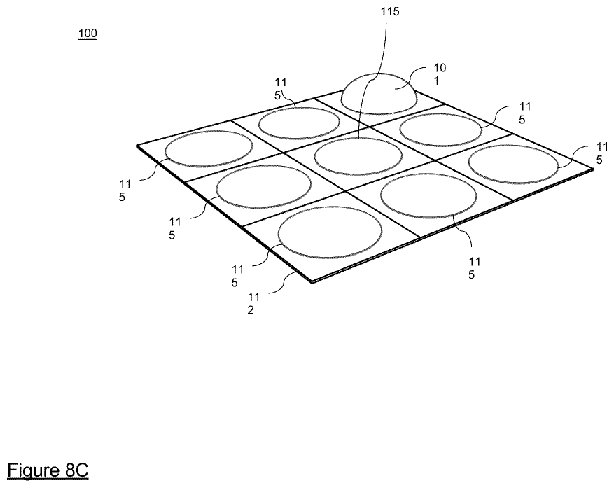

Reference is now made concurrently to FIGS. 8A and 8B, where FIG. 8A is a front view and FIG. 8B is a top view of yet another exemplary implementation of the WPT station 100 illustrated in FIG. 1.

The WPT station 100 comprises the electrode assembly, which comprises the upper membrane 114, the lower membrane 112, and a plurality of electrodes 115 located between the upper membrane 114 and the lower membrane 112.

The WPT station 100 comprises the elevated alignment surface 101 with the transmitter electronic circuit 103 located inside the elevated alignment surface 101. The elevated alignment surface 101 is positioned above the upper membrane 114 and is not located above the group of electrodes 115.

The elevated alignment surface 101 is positioned at an extremity of the electrode assembly, and the plurality of electrodes 115 are located at a distance from the elevated alignment surface 101. More specifically, in the configuration illustrated in FIGS. 8A and 8B, the elevated alignment surface 101 is located above a corner of the upper membrane 114.

The electrical connections for respectively connecting one of the electrodes 115 to the electronic circuit 103 are not represented in FIGS. 8A and 8B for simplification purposes.

FIGS. 8A and 8B illustrate an exemplary configuration where the upper membrane 114 and the lower membrane 112 have a square shape, the electrodes 115 have a circular shape, the plurality of electrodes 115 comprises eight electrodes, and the elevated alignment surface 10 has a semi-spherical shape. A person skilled in the art would readily understand that this exemplary configuration can be adapted, while maintaining the property of having the elevated alignment surface 101 positioned at an extremity of the electrode assembly, and the plurality of electrodes 115 being located at a distance from the elevated alignment surface 101.

Reference is now made concurrently to FIGS. 8A, 8B and 8C, where FIG. 8C is a perspective view of an alternative exemplary implementation of the WPT station 100 illustrated in FIGS. 8A and 8B.

The electrode assembly of the WPT station 100 illustrated in FIG. 8C only comprises the lower membrane 112 but does not comprise an upper membrane 114. The plurality of electrodes 115 are located above the lower membrane 112. As mentioned previously, each electrode 115 comprises its own upper membrane (not represented in FIG. 8C), which plays the role of the upper membrane 114 illustrated in FIGS. 8A and 8B.

Reference is now made concurrently to FIGS. 9A and 9B, where FIGS. 9A and 9B provide a perspective view of still another alternative exemplary implementation of the WPT station 100 illustrated in FIG. 1.

The WPT station 100 comprises the electrode assembly, which comprises the upper membrane 114, the lower membrane 112, and a plurality of electrodes 115. The elevated alignment surface 101 is directly integrated to the upper membrane 114.

In the configuration illustrated in FIGS. 9A and 9B, the elevated alignment surface 101 has a substantially trapezoid shape, and the elevated alignment surface 101 extends over the entire WPT station 100. However, a person skilled in the art would readily understand that this exemplary configuration can be adapted, while maintaining the property of having the elevated alignment surface 101 directly integrated to the upper membrane 114.

In the configuration illustrated in FIG. 9A, the plurality of electrodes 115 are located above the upper membrane 114. In the configuration illustrated in FIG. 9B, the plurality of electrodes 115 are located between the upper membrane 114 and the lower membrane 112.

Although four electrodes 115 are represented in FIGS. 9A and 9B (two on each side of the trapezoidal elevated alignment surface 101), the number of electrodes 115 may vary (e.g., only one electrode 115 on each side of the trapezoidal elevated alignment surface 101).

In the configuration illustrated in FIGS. 9A and 9B, the transmitter electronic circuit 103 represented in FIG. 1 is located between the upper membrane 114 and the lower membrane 112. The transmitter electronic circuit has not been represented in FIGS. 9A and 9B for simplification purposes. At least one of the upper membrane 114 and lower membrane 112 needs to be thicker, so as to allow integration of the transmitter electronic circuit therein.

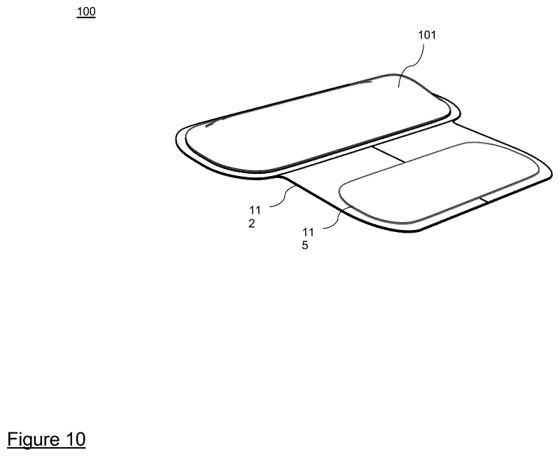

Reference is now made to FIG. 10, where FIG. 10 provides a perspective view of yet another alternative exemplary implementation of the WPT station 100 illustrated in FIG. 1.

The WPT station 100 comprises the electrode assembly, which only comprises the lower membrane 112, but does not comprise an upper membrane. At least one electrode 115 is located above the lower membrane 112. A single electrode 115 is represented in FIG. 10 for illustration purposes only.

The WPT station 100 comprises the elevated alignment surface 101, which is positioned at an extremity of the lower membrane 112 and above the lower membrane 112. The at least one electrode 115 is located at a distance from the elevated alignment surface 101.

In the configuration illustrated in FIG. 10, the transmitter electronic circuit 103 represented in FIG. 1 is located inside the elevated alignment surface 101. The transmitter electronic circuit has not been represented in FIG. 10 for simplification purposes.

Furthermore, FIG. 10 illustrates a configuration where the elevated alignment surface 101 and the at least one electrode 115 are parallel to each other.

Reference is now made concurrently to FIGS. 1 and 11. A schematic representation of the wireless power receiver 200 is provided in FIG. 11. The wireless power receiver 200 is adapted for wirelessly receiving electrical power transmitted (via capacitive coupling) by the WPT station 100 represented in FIG. 1. As mentioned previously, the wireless power receiver 200 may be integrated to various types of electrical motorized vehicles (not represented in FIG. 11 for simplification purposes), which can be recharged via the WPT station 100.

The wireless power receiver 200 comprises an electrode assembly (not identified by a reference number in FIG. 11 for simplification purposes). The electrode assembly comprises an upper membrane 214, a lower membrane 212 and at least one electrode 215 located between the upper membrane 214 and the lower membrane 212. FIG. 11 represents an electrode assembly with two electrodes 215 for illustration purposes only (any number of electrodes 215 may be used). Details related to the implementation of the electrodes 115 of the WPT station 100 are applicable to the electrodes 215 of the wireless power receiver 200. Similarly, details related to the implementation of the upper membrane 114 and lower membrane 112 of the WPT station 100 are applicable to the upper membrane 214 and lower membrane 212 of the wireless power receiver 200.

The wireless power receiver 200 comprises a mechanism for attaching the wireless power receiver 200 to the electrically motorized vehicle. FIG. 11 illustrates an exemplary attachment mechanism, comprising two components 209 adapted to be secured to the upper membrane 214, which are also adapted to be secured to the electrically motorized vehicle.

The wireless power receiver 200 comprises a receiver electronic circuit 203. The wireless power receiver 200 further comprises one electrical connection (not represented in FIG. 11 for simplification purposes) per electrode 215. Each electrical connection electrically connects one of the electrode(s) 215 with the receiver electronic circuit 203.

The receiver electronic circuit 203 comprises electrical and electronic components adapted for adapting and transferring electrical power received via the electrode(s) 215 (from the WPT station 100) to one or more load (e.g., electrical motor, electronic circuit, one or several batteries, etc.) of the electrically motorized vehicle. A detailed description of the components of the receiver electronic circuit 203 is out of the scope of the present disclosure and is well known in the art.

The receiver electronic circuit 203 is located inside a protective container. FIG. 11 illustrates an exemplary protective container comprising an upper portion 202 of a protective box and a lower portion 201 of the protective box.

The wireless power receiver 200 comprises a mechanism for attaching the electrode assembly to the protective container (201 and 202). FIG. 11 illustrates an exemplary attachment mechanism, comprising a component 211 adapted to be secured between the lower membrane 212 and an additional membrane 216. The additional membrane 216 is secured to the upper portion 202 of the protective box. In an alternative configuration (not represented in the Figures), the protective container (201 and 202) comprising the electronic circuit 203 is directly secured to the vehicle, instead of being secured to the electrode assembly via components 211 and 216. In this alternative configuration, longer electrical connections may be needed for connecting the electrodes 215 to the electronic circuit 203.

The present disclosure has been described in the context of a power transfer using capacitive coupling via the electrode(s) 115 of the WPT station 100 and the electrode(s) 215 of the wireless power receiver 200. A person skilled in the art would readily understand that the WPT station 100 and the wireless power receiver 200 can be adapted to perform the energy transfer via induction instead of capacitive coupling. In this case, coils need to be used in place of the electrodes 115 and 215.

### Wireless Power Transfer Station for Wirelessly Powering Electrically Motorized Apparatuses

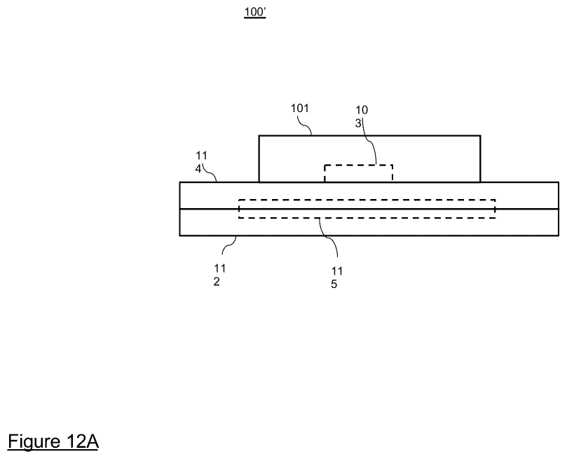

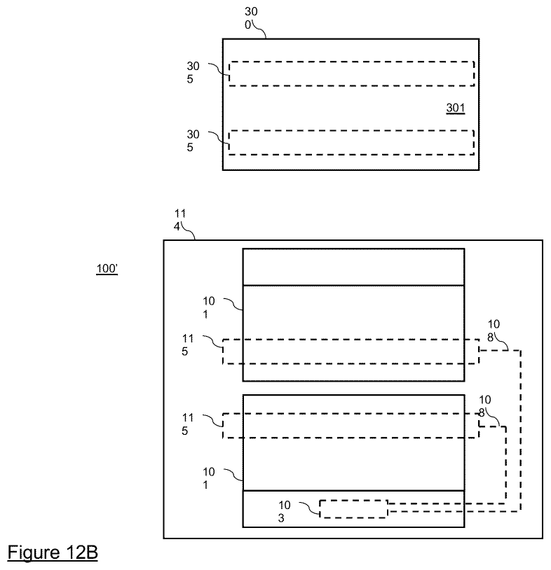

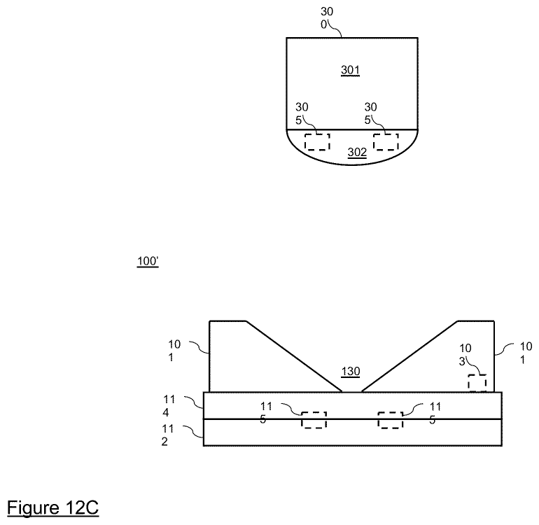

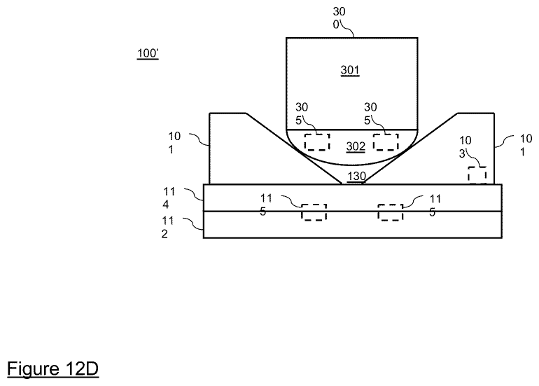

Reference is now made concurrently to FIGS. 12A, 12B, 12C and 12D, which represent an exemplary implementation of a wireless power transfer (WPT) station 100′ for electrically motorized apparatuses. FIGS. 12A and 12B represent respective front and top views of the WPT station 100′. FIGS. 12C and 12D represent a side view of the WPT station 100′.

A schematic representation of the electrically motorized apparatus 300 is provided in FIGS. 12C and 12D. The WPT station 100′ is adapted for wirelessly transmitting electrical power to a wireless power receiver (not represented in FIGS. 12C and 12D for simplification purposes) of the electrically motorized apparatus 300. Details of the wireless power receiver are not provided for simplification purposes. Only the electrodes 305 of the wireless power receiver are represented in FIGS. 12C and 12D. However, a person skilled in the art would readily adapt the wireless power receiver 200 illustrated in FIG. 11 to the electrically motorized apparatus 300.

The wireless power receiver (with the electrodes 305) may be integrated to various types of electrically motorized apparatuses 300, which can be recharged via the WPT station 100′. Examples of electrically motorized apparatuses include rechargeable electric tools (e.g., an electric saw with rechargeable batteries, an electric drilling machine with rechargeable batteries, etc.), a removable rechargeable battery of a rechargeable electric tool (e.g., a large format removable battery for a high power electrical tool), etc.

The WPT station 100′ is similar to the previously described WPT station 100 (in relation to FIGS. 1, 2A, 2B and 2C), except that the WPT station 100′ comprises a plurality of elevations 101.

The WPT station 100′ comprises an electrode assembly. The electrode assembly is not represented in FIGS. 12A, 12B, 12C and 12D, but is similar to the one illustrated in FIGS. 2A, 2B and 2C. The electrode assembly comprises at least one electrode 115, an upper membrane 114 and a lower membrane 112, the at least one electrode 115 being located between the upper membrane 114 and the lower membrane 112.

The WPT station 100′ further comprises a transmitter electronic circuit 103, and at least one electrical connection 108. Each electrical connection 108 electrically connects one of the at least one electrode 115 with the transmitter electronic circuit 103.

The characteristics, properties, configurations, and implementations of the electrode(s) 115, upper membrane 114, lower membrane 112, transmitter electronic circuit 103 and electrical connection(s) 108, which have been previously described in relation to the WPT station 100 illustrated in FIGS. 1, 2A, 2B and 2C, are applicable to the WPT station 100′. Furthermore, at least some of the characteristics, properties, configurations, and implementations of the WPT station 100 illustrated in FIGS. 3A, 3B, 3C, 4A, 4B, 4C, 5A, 5B, 5C, 6A, 6B, 6C, 7A, 7B, 7C, 8A, 8B, 8C, 9A, 9B and 10 can be adapted to the WPT station 100′.

The plurality of elevations 101 of the WPT station 100′ form one or more indentation 130 (represented in FIGS. 12C and 12D). The one or more indentation 130 is adapted for positioning the at least one electrode 305 of the electrically motorized apparatus 300 relative to the at least one electrode 115 of the WPT station 100′, to provide optimal wireless transmission of electrical power from the WPT station 100′ to the electrically motorized apparatus 300.

FIGS. 12A, 12B, 12C and 12D illustrate an exemplary implementation of the WPT station 100′ with two electrodes 115 located between the upper membrane 114 and the lower membrane 112, and two elevations 101 defining one indentation 130. Furthermore, the transmitter electronic circuit 103 is located inside one of the elevations 101. The two electrical connections 108 respectively connecting the two electrodes 115 with the transmitter electronic circuit 103 are only represented in FIG. 12B for simplification purposes.

FIGS. 12B, 12C and 12D provide a schematic simplified representation of an exemplary electrically motorized apparatus 300 comprising a body 301 and a lower section 302 comprising two electrodes 305.

The indentation 130 formed by the two elevations 101 is adapted for receiving the lower section 302 of the electrically motorized apparatus 300 comprising the two electrodes 305, so that the two electrodes 305 of the electrically motorized apparatus 300 are positioned relative to the two electrodes 115 of the WPT station 100′, to provide optimal wireless transmission of electrical power from the WPT station 100′ to the electrically motorized apparatus 300.

The shape, size and respective positions of the two elevated alignment surfaces 101 is determined and adapted to form an indentation 130 for receiving the electrically motorized apparatus 300, that provides the functionality of positioning the two electrodes 305 of the electrically motorized apparatus 300 relative to the two electrodes 115 of the WPT station 100′ for optimal wireless transmission of electrical power.

For instance, in the implementation illustrated in FIGS. 12A-D, the two electrodes 115 and the two electrodes 305 have a longitudinally elongated shape (e.g., a rectangular parallelepiped). The two elevations 101 are parallel to each other, and parallel to the electrodes 115. When, the lower section 302 of the electrically motorized apparatus 300 is received in the indentation 130, the two electrodes 305 are parallel to the two electrodes 115, and each one of the two electrodes 305 is substantially aligned vertically with a corresponding electrode 115.

A person skilled in the art would readily adapt the design of the exemplary WPT station 100′ illustrated in FIGS. 12A, 12B, 12C and 12D, based on characteristics of the electrically motorized apparatus 300 to be charged by the WPT station 100′ (e.g., number of electrodes 305, position of the electrodes 305 within the electrically motorized apparatus 300, etc.). In particular, the number, shape, size, and respective position(s) of the electrode(s) 115 may vary. Similarly, the number, shape, size, and respective positions of the elevations 101 may vary. Additionally, the number, shape, size, and respective position(s) of the indentation(s) 130 may vary.

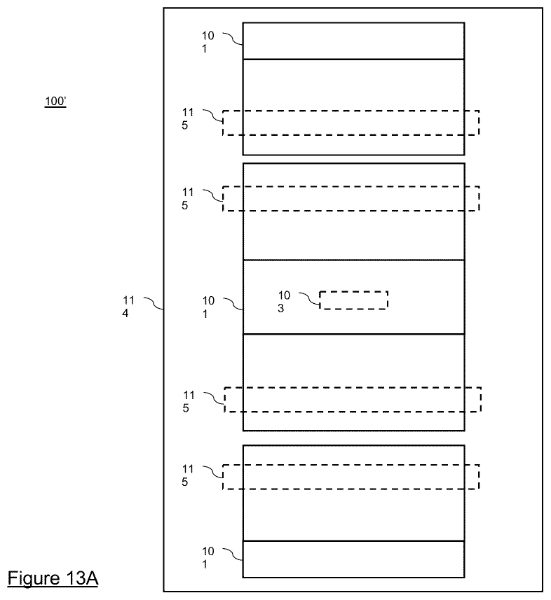

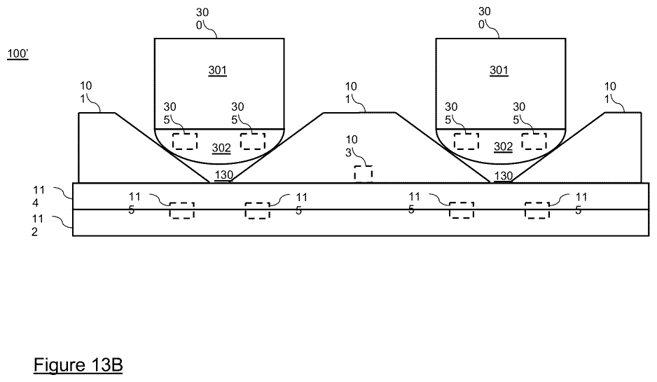

Reference is now made concurrently to FIGS. 13A and 13B, which represent respective top and side views of another exemplary implementation of the WPT station 100′. The WPT station 100′ comprises two groups of two electrodes 115. The WPT station 100′ comprises three elevations 101 defining two indentations 130.

Referring more specifically to FIG. 13B, the left indentation 130 formed by the left elevated alignment surface 101 and the central elevated alignment surface 101 is adapted for receiving the lower section 302 of a first electrically motorized apparatus 300 (left on FIG. 13B) comprising two electrodes 305, so that the two electrodes 305 of the first electrically motorized apparatus 300 are positioned relative to the left group of two electrodes 115 of the WPT station 100′, to provide optimal wireless transmission of electrical power from the WPT station 100′ to the first electrically motorized apparatus 300.

Similarly, the right indentation 130 formed by the right elevated alignment surface 101 and the central elevated alignment surface 101 is adapted for receiving the lower section 302 of a second electrically motorized apparatus 300 (right on FIG. 13B) comprising two electrodes 305, so that the two electrodes 305 of the second electrically motorized apparatus 300 are positioned relative to the right group of two electrodes 115 of the WPT station 100′, to provide optimal wireless transmission of electrical power from the WPT station 100′ to the second electrically motorized apparatus 300.

The implementation illustrated in FIGS. 13A-B is similar to the implementation illustrated in FIGS. 12A-D with respect to the following aspects. The four electrodes 115 and the four electrodes 305 have a longitudinally elongated shape (e.g., a rectangular parallelepiped). The three elevations 101 are parallel to each other, and parallel to the electrodes 115. When, the lower section 302 of one of the electrically motorized apparatuses 300 is received in the corresponding indentation 130, the two electrodes 305 of the electrically motorized apparatus 300 are parallel to the two corresponding electrodes 115, and each one of the two electrodes 305 of the electrically motorized apparatus 300 is substantially aligned vertically with a corresponding electrode 115.

The transmitter electronic circuit 103 is located inside the elevated alignment surface 101.

The two electrically motorized apparatuses 300 are, for example, two rechargeable electrical tools of the same type. Alternatively, the two electrically motorized apparatuses 300 are two removable rechargeable batteries of the same type.

In an alternative exemplary implementation, the WPT station 100′ of FIGS. 13A and 13B is adapted for optimally recharging a single electrically motorized apparatus 300 (not represented in FIG. 13B) comprising two groups of two electrodes 305. Each one of the two indentations 130 is designed for respectively providing optimal wireless transmission of electrical power to one of the two groups of electrodes 305 of the electrically motorized apparatus 300.

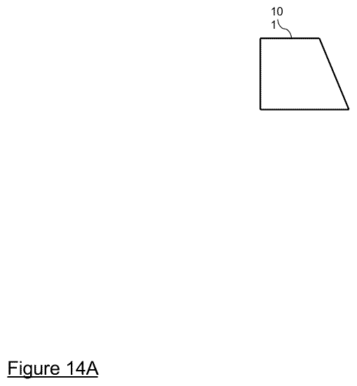

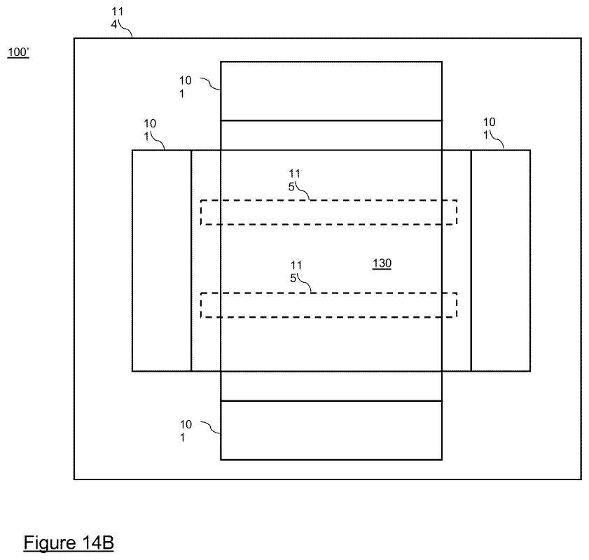

Reference is now made concurrently to FIGS. 14A and 14B. FIG. 14A represents a side view of an exemplary implementation of the elevated alignment surface 101. FIG. 14B represents a top view of another exemplary implementation of the WPT station 100′ using four elevated alignment surfaces illustrated in FIG. 14A.

The four elevations 101 are positioned so that two adjacent elevations 101 are perpendicular to one another, to define a single central indentation 130 having a square shape. For illustration purposes, the WPT station 100′ comprises two electrodes 115. The indentation 130 is, for example, adapted to receive a lower section of an electrically motorized apparatus (not represented in FIG. 14B for simplification purposes) having substantially the shape of a frustrum of a pyramid.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A wireless power transfer station for wirelessly transmitting electrical power to an electrical motorized vehicle, the station comprising:
an electrode assembly comprising at least one electrode, an upper membrane and a lower membrane, the at least one electrode being located between the upper and lower membranes;
a transmitter electronic circuit;
at least one electrical connection, each electrical connection electrically connecting one of the at least one electrode to the transmitter electronic circuit; and
an elevated alignment surface adapted for protecting the transmitter electronic circuit, the elevated alignment surface aligning the electrical motorized vehicle over the wireless power transfer station to optimize power transfer from the wireless power transfer station to the electrical motorized vehicle.

2. The wireless power transfer station of claim 1, wherein the transmitter electronic circuit is located inside the elevated alignment surface.

3. The wireless power transfer station of claim 1, wherein the elevated alignment surface is positioned above the upper membrane, the elevated alignment surface is encapsulated inside the upper membrane, or the elevated alignment surface is integrated to the upper membrane.

4. The wireless power transfer station of claim 1, wherein the at least one electrode is encapsulated between the upper and lower membranes.

5. The wireless power transfer station of claim 1, wherein at least one of the upper membrane and the lower membrane is made of a material having at least one of the following characteristics: waterproof, weatherproof, anti-slip, resistant to mechanical constraints, dielectric and electrical insulator.

6. The wireless power transfer station of claim 1, wherein the at least one electrode generates a capacitive electric field.

7. The wireless power transfer station of claim 6, wherein the capacitive electric field is a resonant capacitive electric field.

8. The wireless power transfer station of claim 1, wherein the elevated alignment surface is further adapted for aligning the electrical motorized vehicle with respect to the electrode assembly, the wireless power transfer station wirelessly transmitting electrical power to the electrical motorized vehicle when the electrical motorized vehicle is aligned with respect to the elevated alignment surface.

9. The wireless power transfer station of claim 1, wherein the electrode assembly is positioned above a floor, and a shape of the elevated alignment surface provides for abutting at least one wheel of the electrical motorized vehicle against the elevated alignment surface when the at least one wheel is located on top of the upper membrane.

10. The wireless power transfer station of claim 1, wherein the electrode assembly further comprises one passive plate for each electrode, each passive plate being located between the upper membrane and the lower membrane.

11. A wireless power transfer station for wirelessly transmitting electrical power to an electrically motorized apparatus comprising at least one electrode, the station comprising:
an electrode assembly comprising at least one electrode, an upper membrane and a lower membrane, the at least one electrode being located between the upper and lower membranes;
a transmitter electronic circuit;
at least one electrical connection, each electrical connection electrically connecting one of the at least one electrode with the transmitter electronic circuit; and
a plurality of elevated alignment surfaces forming one or more indentation, the one or more indentation positioning the electrical motorized apparatus relative to the at least one electrode of the station to provide optimal wireless transmission of electrical power from the wireless power transfer station to the electrically motorized apparatus.

12. The wireless power transfer station of claim 11, wherein the transmitter electronic circuit is located inside one of the plurality of elevated alignment surfaces.

13. The wireless power transfer station of claim 11, wherein the plurality of elevated alignment surfaces are positioned above the upper membrane, the plurality of elevated alignment surfaces are encapsulated inside the upper membrane, or the plurality of elevated alignment surfaces are integrated to the upper membrane.

14. The wireless power transfer station of claim 11, wherein the at least one electrode is encapsulated between the upper and lower membranes.

15. The wireless power transfer station of claim 11, wherein at least one of the upper membrane and the lower membrane is made of a material having at least one of the following characteristics: waterproof, weatherproof, anti-slip, resistant to mechanical constraints, dielectric and electrical insulator.

16. The wireless power transfer station of claim 11, wherein the at least one electrode generates a capacitive electric field.

17. The wireless power transfer station of claim 16, wherein the capacitive electric field is a resonant capacitive electric field.

18. The wireless power transfer station of claim 11, wherein the electrical motorized apparatus is one of the following: a rechargeable electrical tool or a removable rechargeable battery.

19. The wireless power transfer station of claim 11, wherein the electrode assembly further comprises one passive plate for each electrode, each passive plate being located between the upper membrane and the lower membrane.
